(19) United States
(12) Patent Application Publication
(10) Pub. No.: US 2005/0212824 A1
(43) Pub. Date: Sep. 29, 2005

(54) Dynamic display control of a portable electronic device display

(76) Inventors: Walter M. Marcinkiewicz, Apex, NC (US); Brett A. Pantalone, Willow Spring, NC (US); Terrence E. Rogers, Durham, NC (US)

Correspondence Address: COATS & BENNETT/SONY ERICSSON, 1400 CRESCENT GREEN, SUITE 300, CARY, NC, 27511, US

(21) Appl. No.: 10/809,132

(22) Filed: Mar. 25, 2004

(51) Int. Cl. G09G 3/36

(52) U.S. Cl. 345/690

(57) ABSTRACT

A method and apparatus improves the visibility of information displayed on a portable electronic device display in various ambient lighting conditions. The portable electronic device measures the ambient light associated with the display and adjusts the display based on the measured ambient light to improve the visibility of the displayed information. In an exemplary embodiment, light detection electronics detect the ambient light associated with the display. A light processor processes the raw data to determine the measured ambient light based on the detected ambient light. A display controller of the portable electronic device adjusts the display based on the measured ambient light. An exemplary display controller may adjust the size of the displayed information, a backlight intensity of the display, or a display contrast based on the measured ambient light.

### BACKGROUND OF THE INVENTION

The present invention relates generally to portable electronic device displays, and more particularly to the visibility of information displayed on the portable electronic device display.

Portable electronic devices, such as cellular telephones, laptop computers, digital cameras, calculators, personal data assistants, and the like, include displays for providing information to the user. The displayed information may be as simple as the current time and may be as detailed as an image associated with a photograph, computer game, or movie.

Typically, various display parameter settings, such as the size of the displayed information, the display contrast, the backlight intensity of the display, etc., affect the visibility of the displayed information. However, the visibility of the displayed information also varies based on ambient lighting conditions. For example, in bright light environments, such as an outdoor setting, the visibility of the displayed information may be compromised due to glare caused by the ambient light and/or the presence of an insufficiently bright backlight; in low light environments, the backlight may enhance the visibility of the displayed information.

Some devices allow the user to control specific display parameter settings, such as setting the font to a desired size or setting the backlight to always on, always off, or automatic. Typically, the user navigates through a series of menus to adjust the desired setting. However, such navigation can be very difficult in poor visibility conditions when the displayed information is invisible or nearly invisible to the user due to the ambient lighting conditions. Further, once set by the user, these parameters are fixed, and therefore, are fixed for all ambient lighting conditions.

### SUMMARY OF THE INVENTION

The present invention comprises a method and apparatus that improves the visibility of information on a portable electronic device display in various ambient lighting conditions. According to the present invention, the display is adjusted based on measured ambient light to improve the visibility of the displayed information. In an exemplary embodiment, light detection electronics in the portable electronic device determine a measured ambient light, and a display controller adjusts the display on the portable electronic device based on the measured ambient light.

In exemplary embodiments, the display controller may adjust one or more display parameters, such as the size of displayed information, the display contrast, and/or the backlight intensity of the display. Such display control may occur automatically or may occur in response to user input.

### BRIEF DESCRIPTION OF THE DRAWINGS

FIG. 1 illustrates an exemplary block diagram of a portable electronic device of the present invention.

FIG. 2 illustrates an exemplary display control method of the present invention.

FIG. 3 illustrates contrast versus spatial frequency.

FIGS. 4A-4D illustrate exemplary display controllers of the present invention.

FIG. 5 illustrates backlight intensity versus ambient lighting.

FIG. 6A illustrates contrast bias voltages versus ambient lighting.

FIG. 6B illustrates the effects of temperature on contrast bias voltage.

FIG. 7 illustrates another exemplary display control method of the present invention.

FIG. 8 illustrates an exemplary block diagram of another portable electronic device of the present invention.

FIG. 9 illustrates another exemplary display controller of the present invention.

### DETAILED DESCRIPTION OF THE INVENTION

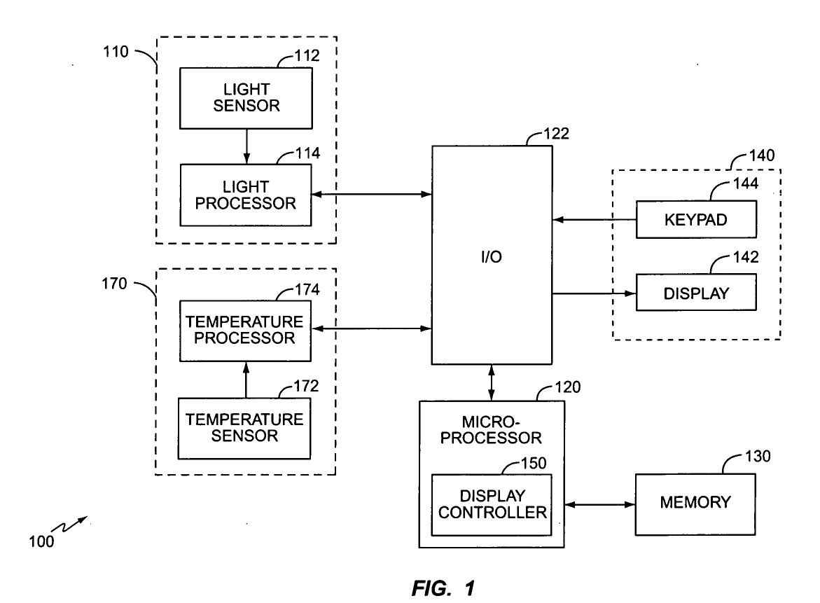

FIG. 1 illustrates an exemplary portable electronic device 100, such as a cellular telephone, laptop computer, MP3 player, CD player, digital camera, portable radio, calculator, personal data assistant, portable gaming system, DVD player, etc., of the present invention. Portable electronic device 100 includes light detection electronics 110, microprocessor 120, input/output circuit 122, memory circuit 130, user interface 140, and optionally, temperature detection electronics 170.

Light detection electronics 110, including a light sensor 112 and an optional light processor 114, determines a measured ambient light associated with the portable electronic device 100. Light sensor 112 is any conventional light sensor device, such as a charge-coupled device (CCD) or a complementary metal oxide semiconductor (CMOS), that captures light from the environment. Light processor 114 may be any conventional processor, such as a digital signal processor, programmed to process raw data captured by light sensor 112. In exemplary embodiments, light processor 114 may average the light captured by light sensor 112 over a predefined period of time, and define the average light as the measured ambient light. In some embodiments, light detection electronics 110 may be part of a camera system within the portable electronic device 100. While FIG. 1 illustrates that light processor 114 is part of the light detection electronics 110, it will be appreciated that light processor 114 is not required for the present invention. For example, in some embodiments, the ambient light detected by light sensor 112 may serve as the measured ambient light. Further, while light sensor 112 and light processor 114 are shown as separate electronic devices, it will be appreciated that light sensor 112 and light processor 114 may be combined into a single electronic device. In some embodiments, light detection electronics 110 may be part of a camera system within the portable electronic device 100.

Detection electronics 110 provide the measured ambient light to microprocessor 120 via an input/output circuit 122 according to any means known in the art. In addition, input/output circuit 122 interfaces microprocessor 120 with a user interface 140. User interface 140 includes one or more displays 142 and a keypad 144. Display 142 allows the user to see text, images, menu options, and other device information, and may comprise any known display 142, such as a liquid crystal display, a thin film transistor display, a thin film diode display, an organic light emitting diode display, or a super twisted nematic display. Keypad 144 includes one or more control buttons, and may include an alphanumeric keypad and/or a navigation control, such as joystick control, as is well known in the art. Further, keypad 144 may comprise a full keyboard, such as those used with laptop computers. Keypad 144 allows the operator to enter commands and select options stored in memory 130.

Memory 130 represents the entire hierarchy of memory in portable electronic device 100, and may include both random access memory (RAM) and read-only memory (ROM). Computer program instructions and data required for operation are stored in non-volatile memory, such as EPROM, EEPROM, and/or flash memory, which may be implemented as discrete devices, stacked devices, or integrated with microprocessor 120. Microprocessor 120 controls the operation of portable electronic device 100 according to the programs stored in memory 130. The control functions may be implemented in a single microprocessor, or in multiple microprocessors. Suitable microprocessors may include, for example, both general purpose and special purpose microprocessors and digital signal processors.

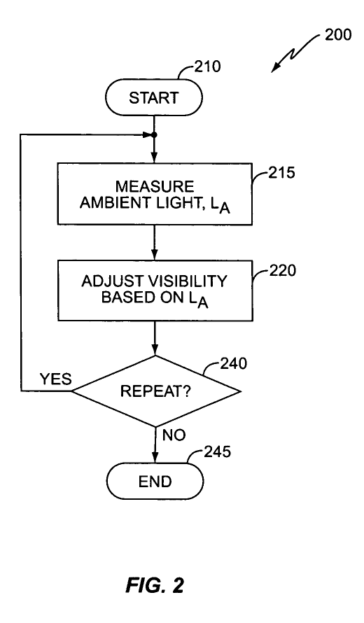

As shown in FIG. 1, microprocessor 120 also includes a display controller 150 for controlling display 142 according to the present invention. While FIG. 1 shows display controller 150 interfacing with display 142 via input/output circuit 122, those skilled in the art will appreciate that display controller 150 may directly interface with display 142. In any event, display controller 150 implements an exemplary method 200 for improving the visibility of information displayed on display 142, as illustrated in FIG. 2. After the method begins (block 210), light detection electronics 110 measure the ambient light (L_{A}) proximate the portable electronic device 100 and associated with display 142 (block 215). In response, portable electronic device 100 adjusts the display based on the measured ambient light (block 220), as discussed further below. Portable electronic device 100 repeats (block 240) the steps of measuring the ambient light (block 215) and adjusting the display based on the measured ambient light (block 220) until the portable electronic device 100 ends the process (block 245).

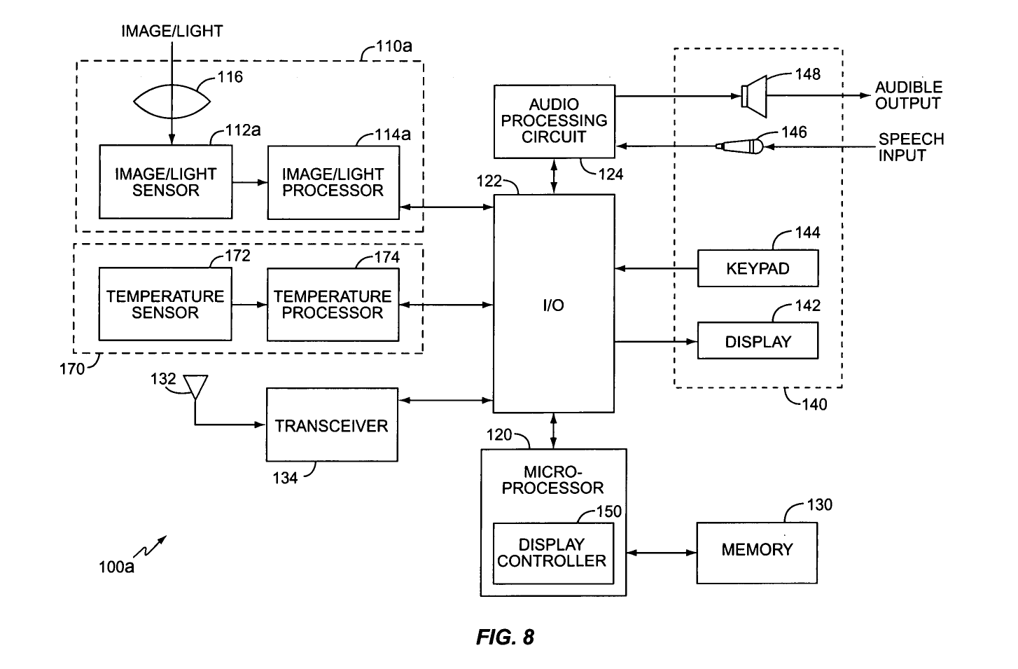

Portable electronic device 100 starts and ends the display control process 200 based on any number of user inputs and/or user settings. For example, when the user sets the display control setting to automatic, display controller 150 may begin the display control process 200 any time portable electronic device 100 enters an operational state, i.e., when the user powers up the portable electronic device 100. Portable electronic device 100 may end the display control process 200 when the portable electronic device 100 enters a stand-by state or after a predetermined time period has elapsed. In addition, the user may manually activate/deactivate the display control process 200 by touching any control button on keypad 144. Similarly, for those portable electronic devices 100 with audio equipment, such as a microphone 146, speaker 148, and audio processor 124 (see FIG. 8), the user may activate the display control process 200 with an audio command. In any event, it will be appreciated that display controller 150 may start and end the display control process 200 automatically and/or in response to a user input.

Once display controller 150 implements the display control process 200, display controller 150 adjusts the display 142 by adjusting one or more display parameters based on the measured ambient light. In exemplary embodiments, display controller 150 may interface with memory 130 to determine the appropriate display adjustment based on the measured ambient light. Memory 130 may include one or more visibility tables, where each visibility table includes a display adjustment parameter for each of a plurality of ambient light values. Display controller 150 retrieves the display adjustment value(s) from the one or more visibility tables stored in memory 130 based on the measured ambient light, and adjusts the display based on the retrieved display adjustment value(s).

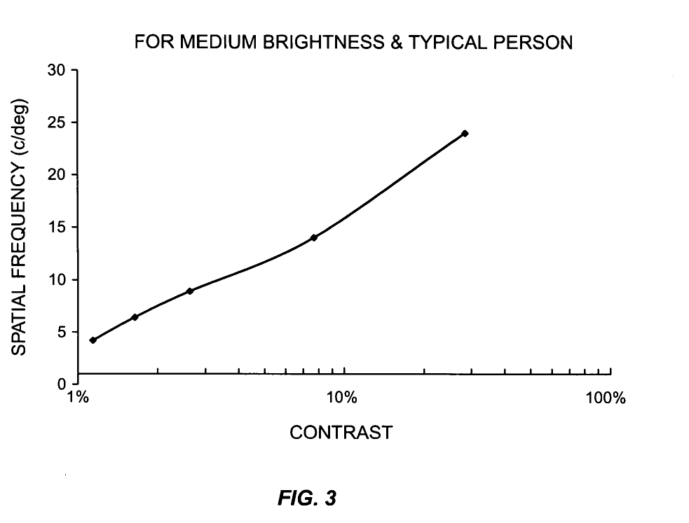

In exemplary embodiments, display controller 150 may include one or more parameter controllers that determine the appropriate display adjustment parameter(s) based on the measured ambient light. To illustrate how ambient light affects the visibility of displayed information, FIG. 3 plots human visual acuity for a typical person in medium lighting. Natural variations amongst individuals or reasonable illumination adjustments will not alter the validity. In general, higher spatial frequencies correspond to finer detail in images and text. For example, spatial frequency corresponds to the closest spaced lines in a font. Therefore, a smaller text font requires higher spatial frequencies than a larger text font of the same type. As shown in FIG. 3, if the contrast is reduced, then only lower spatial frequencies are visible. In other words, if the contrast is reduced, only larger objects can be clearly seen on a display.

Contrast may defined as:

$$Contrast \% = 100 \times \frac{Δ L}{{L}_{avg}} = 100 \times ( \frac{{L}_{max} - {L}_{min}}{{L}_{max} + {L}_{min}} ) \qquad ( Eq . 1 )$$

where L_{avg} represents the average brightness of a bright & dark patterns on the display, ΔL represents the difference in brightness from the average for bright & dark areas of the display, Lₘₐₓ represents brightness of a bright test area on the display screen, and Lₘᵢₙ represents brightness of a dark test area on the display screen. If the bright areas of a display in a dim room have an L_{avg} value of 30 on some scale due to the display's internal backlight, and the nearby or fine detail darkest areas of the display have an Lₘᵢₙ value 1, then the resulting contrast in dim ambient light is:

$$Contrast \% = 100 \times ( \frac{{L}_{max} - {L}_{min}}{{L}_{max} + {L}_{min}} ) = 100 \times ( \frac{30 - 1}{30 + 1} ) = 93.5 \% \qquad ( Eq . 2 )$$

As shown in FIG. 3 (using extrapolation), this contrast percentage corresponds to a spatial frequency of approximately 30 cycles/degree. As a result, in dim ambient light, a typical person can see details with a spatial frequency of approximately 30 cycles/degree on the display or equivalent thereof.

If the display is relocated to an area of bright lighting, then in even the best designs there is considerable scattering of the ambient light from all parts of the display caused by glare that is largely unavoidable. In a typical case, twice as much ambient light is scattered from both dark and light areas as is emitted by the display. Therefore, in the example provided above, this scattering causes Lₘₐₓ and Lₘᵢₙ to both increase by 60. As a result, the contrast percentage in bright ambient light is:

$$Contrast \% = 100 \times ( \frac{{L}_{max} - {L}_{min}}{{L}_{max} + {L}_{min}} ) = 100 \times ( \frac{( 30 + 60 ) - ( 1 + 60 )}{( 30 + 60 ) + ( 1 + 60 )} ) = 19.2 \% \qquad ( Eq . 3 )$$

As shown in FIG. 3, this contrast % corresponds to a spatial frequency of approximately 20 cycles/degree. Therefore, to see the same text in bright ambient light that was visible in dim ambient light, the display controller may, for example, increase the font size by 50%.

Displays not using back lighting also suffer a functional reduction in contrast at the highest lighting levels because of the non-linear response of the eye to bright light. A display making use of ambient lighting also loses apparent contrast when the lighting is low again because of non-linear eye response but at low light levels. In either case, the display controller may adjust one or more display parameters, such as the size of the displayed information, the display contrast, etc., to improve the visibility of the displayed information.

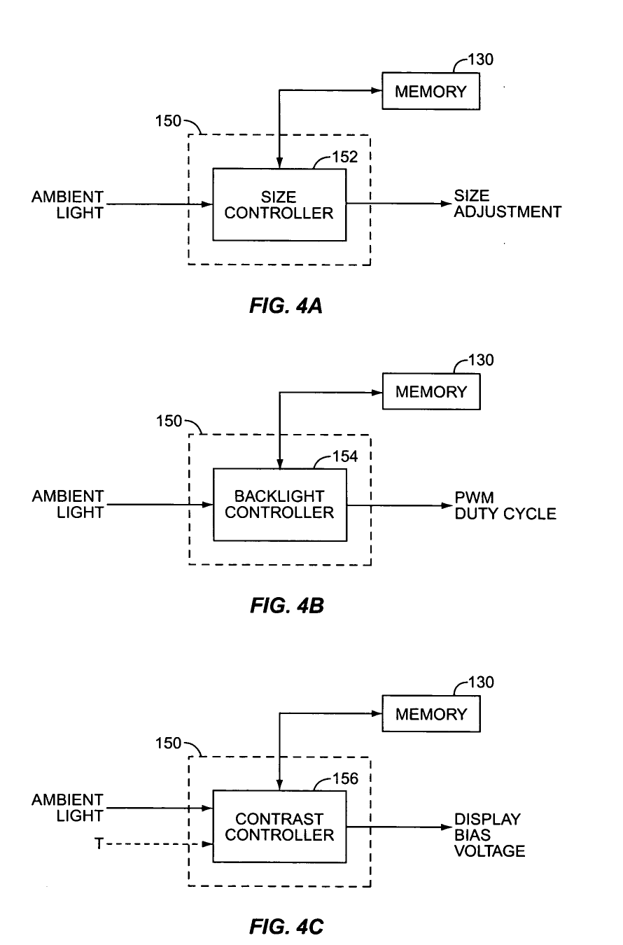

In an exemplary embodiment, display controller 150 may include a size controller 152, shown in FIG. 4A, that adjusts the spatial frequency of image details by adjusting the size of the displayed information in response to a measured ambient light. As the measured ambient lighting increases, the display contrast decreases. In response, size controller 152 may increase the size of the displayed information to decrease the spatial frequency of the displayed information details, and therefore, to improve the visibility of the displayed information. Similarly, as the lighting in the environment decreases, size controller 152 decreases the size of the displayed information to increase the spatial frequency of the displayed information and therefore to maintain the desired visibility while simultaneously increasing the amount of space available on display 142 for displaying information. If a backlight is not used, the controller may instead adjust image details to a larger size or higher contrast if available when lighting is either low or very bright.

The size of the displayed information may be adjusted according to any means known in the art. For example, for the display controller 150 of FIG. 4A, the visibility table stored in memory 130 may be a size adjustment table that includes a size adjustment parameter for each of a plurality of ambient light values. Based on the measured ambient light, size controller 152 retrieves the corresponding size adjustment parameter from the size adjustment table stored in memory 130. Size controller 152 uses the retrieved size adjustment parameter to adjust the size of the information displayed on display 142 to improve the visibility of the displayed information in the current lighting condition.

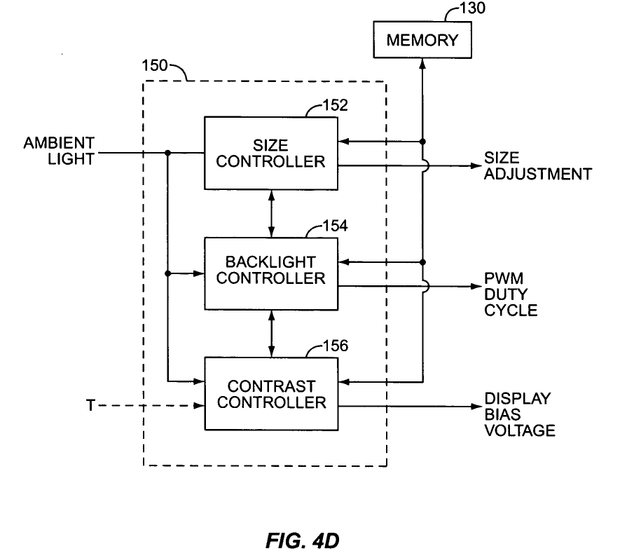

In another exemplary embodiment, shown in FIG. 4B, display controller 150 may include a backlight controller 154 that controls the backlight intensity of display 142 based on the measured ambient light. Because brighter ambient light tends to wash out information displayed on a backlit display 142, backlight controller 154 may improve the visibility of the displayed information by decreasing the backlight intensity as the ambient light increases. FIG. 5 illustrates an exemplary relationship between backlight intensity and ambient light. By adjusting the backlight intensity based on the ambient lighting condition, display controller not only improves the visibility of the displayed information, but also improves the efficiency of the backlight and power consumption of the portable electronic device 100 by only providing the necessary backlight intensity necessary for good visibility.

The backlight intensity of display 142 may be adjusted according to any means known in the art. For example, to adjust the backlight intensity of a conventional display 142, such as a liquid crystal display (LCD), backlight controller 154 adjusts the pulse width modulation (PWM) duty cycle of the supply voltage for the display 142. For the embodiment of FIG. 4B, the visibility table stored in memory 130 may be a backlight adjustment table that includes a PWM duty cycle for each of a plurality of ambient light values. Based on the measured ambient light, backlight controller 154 retrieves the corresponding PWM duty cycle from the backlight adjustment table stored in memory 130, and uses the retrieved PWM duty cycle to adjust the backlight intensity of display 142 to improve the visibility of the displayed information in the current lighting condition.

In still another exemplary embodiment, shown in FIG. 4C, display controller 150 includes a contrast controller 156 that controls the display contrast of display 142 based on the measured ambient light. Because brighter ambient light tends to wash out information displayed on a backlit display 142, contrast controller 156 may improve the visibility of the displayed information by increasing the display contrast as the ambient light increases.

Contrast controller 156 may adjust the display contrast according to any means known in the art. In one embodiment, contrast controller 156 may adjust the display contrast by adjusting the font type and/or the font and background color. For example, dependent on the measured ambient light, contrast controller 156 may change the font color to black and the background color to white to provide better display contrast.

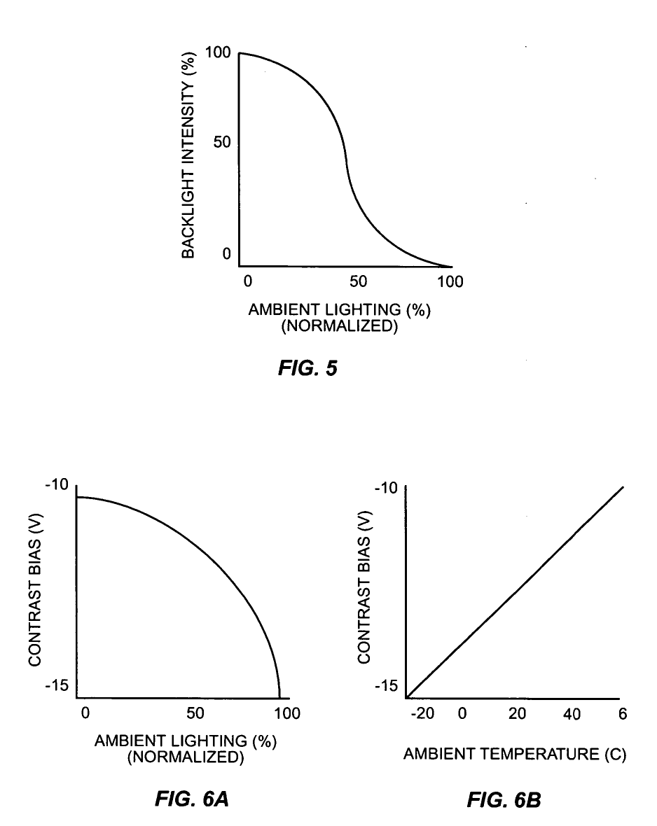

Alternatively, the display bias voltage may be adjusted to adjust the display contrast of a conventional display 142, such as an LCD. FIG. 6A illustrates an exemplary relationship between contrast bias and ambient light. As with the above-described embodiments, memory 130 in the embodiment of FIG. 4C may store a contrast adjustment table that includes a bias voltage for each of a plurality of ambient light values. Based on the measured ambient light, contrast controller 156 retrieves the corresponding bias voltage from the contrast adjustment table stored in memory 130. Contrast controller 156 uses the retrieved bias voltage to adjust the display contrast of display 142 to improve the visibility of the displayed information in the current lighting condition.

As shown in FIG. 6B, the bias voltage of conventional displays 140 is often temperature sensitive. Therefore, to improve the accuracy of the bias voltage adjustment used to adjust the display contrast, contrast controller 156 may temperature compensate the bias voltage in some embodiments of the present invention. To implement the temperature compensation, contrast controller 156 may adjust the bias voltage based on the measured ambient light and a temperature of the display 142. For example, memory 130 may store a two-dimension contrast adjustment table that cross-references a bias voltage for a plurality of ambient light values and display temperatures. In an exemplary embodiment, one index of the two-dimensional contrast adjustment table may be a temperature index and the other index may be an ambient light index, as illustrated in Table 1.

TABLE 1
2D Bias Voltage Table

| Temperature | Ambient Light (normalized %) | | | | |
|---|---|---|---|---|---|
| (° C.) | 0 | 25% | 50% | 75% | 100% |
| −20 | −15 | −15 | −15 | −15 | −15 |
| 0 | — | — | — | — | — |
| 20 | — | — | — | — | — |
| 40 | — | — | — | — | — |
| 60 | −13 | −12 | −10 | −10 | −12 |

Bias Voltage (V)

The value at the junction of the two indices represents the optimum bias voltage for the current ambient light and display temperature.

To determine the display temperature for contrast controller 156, portable electronic device 100 may include the temperature detection electronics 170 shown in FIG. 1. Temperature detection electronics 170 include a temperature sensor 172 and an optional temperature processor 174. In an exemplary embodiment, temperature sensor measures an ambient temperature proximate the portable electronic device 100. Temperature processor 174 then calculates the display temperature based on the measured ambient temperature and knowledge of the temperature characteristics of the electronics in portable electronic device 100. Further, temperature processor 174 may calculate an average display temperature over a predefined period of time, and define the display temperature as the average display temperature.

While FIG. 1 illustrates temperature detection electronics that include both a temperature sensor 172 and temperature processor 174, those skilled in the art will appreciate that temperature processor 174 may be omitted when further processing to the temperature provided by temperature sensor 172 is not required, such as when temperature sensor 172 directly measures the temperature of display 142.

Further, while temperature sensor 172 and temperature processor 174 are shown as separate electronic devices, it will be appreciated that the temperature sensor 172 and the temperature processor 174 of temperature detection electronics 170 may be combined into a single electronic device.

While FIGS. 4A-4C illustrate a display controller 150 with only a size controller 152, a backlight controller 154, or a contrast controller 156, it will be appreciated that the present invention is not so limiting. In fact, display controller 150 may include two or more of the size, backlight, and/or contrast controller (152, 154, and 156). For example, as shown in FIG. 4D, display controller 150 may include a size controller 152, a backlight controller 154, and a contrast controller 156. In this embodiment, based on the measured ambient light, size controller 152 adjusts the size of the displayed information, backlight controller 154 adjusts the backlight intensity, and contrast controller 156 adjusts the display contrast to improve the overall visibility of the displayed information. As with the above described contrast controller, the bias voltage adjustment may also be temperature compensated based on the temperature T provided by the temperature detection electronics 170. It will be appreciated that these controllers 152, 154, 156 may operate independently. Alternatively, one or more of these controllers 152, 154, 156 may interact to optimize the display adjustment parameters provided by each controller.

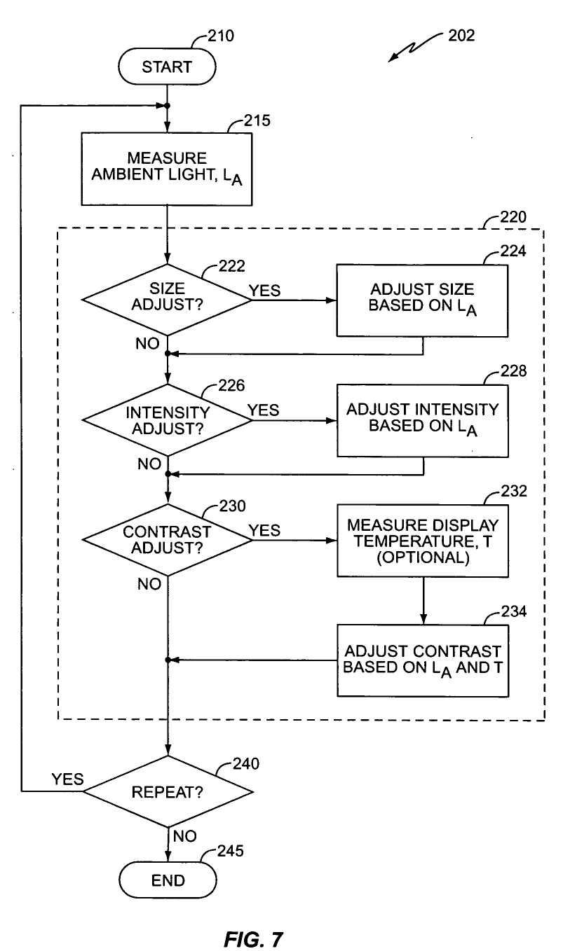

FIG. 7 illustrates an exemplary display control method 202 for a portable electronic device 100 using the display controller 150 of FIG. 4D. After the method begins (block 210), the light detection electronics 110 of portable electronic device 100 measures the ambient light LA proximate the portable electronic device 100 and associated with the display 142 (block 215). The portable electronic device 100 adjusts the display 142 based on the measured ambient light (block 220) to improve the visibility of the displayed information. To adjust the display, the size of the displayed information, the backlight intensity, and/or the display contrast may be adjusted. When the size of the displayed information should be adjusted (block 222), size controller 152 adjusts the size based on the measured ambient light (block 224). When the backlight intensity of the display 142 should be adjusted (block 226), backlight controller 154 adjusts the backlight intensity based on the measured ambient light (block 228). When the display contrast should be adjusted (block 230), contrast controller 156 adjusts the display contrast based on the measured ambient light (block 234). For portable electronic devices 100 that include temperature compensation, the temperature detection electronics 170 determines the display temperature (block 232) and contrast controller 156 adjusts the display contrast based on the measured ambient light and the display temperature (block 234). Portable electronic device 100 repeats (block 240) the steps of measuring the ambient light (block 215) and adjusting the display based on the ambient light (block 220) until the portable electronic device 100 ends the process (block 245). Those skilled in the art will appreciate that the method 202 is not limited to the sequence of display adjustment steps shown in FIG. 2; display controller 150 of FIG. 4D may implement the display adjustment steps in any desired order.

While not shown, it will be appreciated that other display control methods may be implemented by display controller 150 of FIG. 4D. For example, after size controller 152 determines the size adjustment, backlight controller 154 may determine the appropriate backlight intensity adjustment based on the measured ambient light and the size adjustment determined by the size controller 152. In other words, each display controller may interact to determine the best display adjustment parameter(s) for the given lighting conditions.

While the above examples describe specific embodiments, it will be appreciated by those skilled in the art that the present invention is not limited to these examples. As such, the portable electronic device 100 of FIG. 1 may be any portable electronic device known in the art, including cellular telephones, laptop computers, MP3 players, CD players, digital cameras, calculators, personal data assistants, portable gaming systems, DVD players, palm top computers, personal communication service (PCS) devices, and the like. Further, light detection electronics 110 may be any known light detection electronics, including cameras currently integrated with cellular telephones and other portable electronic devices.

FIG. 8 illustrates a cellular telephone 100a implementing the present invention. In addition to the electrical components shown in FIG. 1 and described above, cellular telephone 100a includes an antenna 132 coupled to a transceiver 134 for transmitting and receiving wireless communication signals, according to the instructions stored in memory 130 and controlled by microprocessor 120. Transceiver 134 is a fully functional cellular radio transceiver, which may operate according to any known standard, including the standards known generally as the Global System for Mobile Communications (GSM), TIA/EIA-136, cdmaOne, cdma2000, UMTS, and Wideband CDMA.

Cellular telephone 100a also includes a microphone 146 and a speaker 148, in user interface 140, that interface with an audio processing circuit 124, as known in the art. Microphone 146 converts the user's speech into electrical audio signals. Audio processing circuit 124 accepts the analog audio inputs from microphone 146, processes these signals, and provides the processed signals to transceiver 134 via input/output circuit 122. Audio signals received by transceiver 134 are processed by audio processing circuit 124. The analog output signals produced by audio processing circuit 124 are provided to speaker 148. Speaker 148 then converts the analog audio signals into audible signals that can be heard by the user.

While some cellular telephones 100a may include the basic light detection electronics 110 shown in FIG. 1, others may replace the basic light detection electronics 110 with a camera assembly 11a, as shown in FIG. 8. Camera assembly 110a includes camera lens 116, image/light sensor 112a, and image/light processor 114a. Camera lens 116, comprising a single lens or a plurality of lenses, collects and focuses light onto image/light sensor 112a in response to control signals from microprocessor 120. Image/light processor 114a processes raw data captured by image/light sensor 112a. Like the light sensor 112 discussed above, image/light sensor 112a may be any conventional sensor, such as a charge-coupled device (CCD) or a complementary metal oxide semiconductor (CMOS) image sensor. According to the present invention, camera assembly 11a provides the measured ambient light to display control 150 via input/output circuit 122. Further, camera assembly 110a may also capture images for subsequent storage in memory 130, output to display 142, and/or for transmission by transceiver 134.

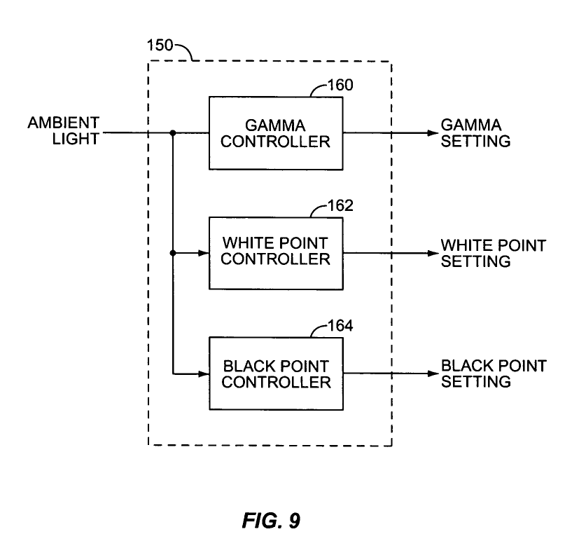

While the above describes display control in terms of information size, backlight intensity, and display contrast control, those skilled in the art will appreciate that the present invention is not so limiting. For example, display controller 150 may include at least one of a gamma controller 160, a white point controller 162, and/or a black point controller 164, as shown in FIG. 9, for further enhancing the visibility of displayed information, particularly when the information is displayed in color. One or more of these controllers may be used to improve the visibility of the displayed information while also improving the efficiency of the portable electronic device 100 by minimizing the amount of processed and stored color data for different lighting conditions. For example, based on the measured ambient light, the white and/or black point settings may be set to limit the number of colors displayed. As the ambient light increases, for example, the white point controller 162 may increase the white point setting and/or the black point controller 164 may decrease the black point setting to reduce the number of colors displayed. As a result, visibility of the displayed information is improved. Further, the processing and data storage required to generate the displayed information is limited to only that which is necessary to produce the desired image quality. A similar principle applies to the gamma controller 160. Gamma controller 160 generates a gamma point setting that defines the uniform intensity of the displayed information. As the ambient light increases, gamma controller 160 decreases the gamma point setting to improve the visibility of the displayed image.

It will be appreciated that while FIGS. 4A-4D and FIG. 9 illustrate specific display controllers 150, display controller 150 may include any combination of one or more of the above described size controller 152, backlight controller 154, contrast controller 156, gamma controller 160, white point controller 162, and/or black point controller 164. Further, the display controller 150 may include any other known display parameter controller that impacts the visibility of display 142.

Further, while FIG. 1 only shows a single display, those skilled in the art will appreciate that multiple displays may be incorporated with and/or used by a single portable electronic device 100. For example, a cellular telephone with a clamshell housing may have a primary display on an inner side of the clamshell and a secondary display on an outer side of the clamshell. Alternatively, a laptop computer may selectively interface with a portable display disposed in the laptop housing and/or a fixed display on, for example, a desktop. In any event, each display may be made from the same type of display or from different types of displays. When made from different types of displays, display controller 150 may determine the display parameter settings for one display 142 and further convert the setting(s) to the format appropriate for another second display 142. Such conversion techniques are known in the art, and therefore, are not discussed further herein. However, for illustration, an exemplary embodiment of the present invention that includes two different displays may use an Image Interchange Standard (IIS), such as the Basic Image Interchange Format (BIIF) based on the National Imagery Transmission Format Standard (NITFS), to convert the display parameter settings for one display 142 to appropriate display parameter settings for the other display 142.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method of improving visibility of information on a display of a portable electronic device comprising:
measuring ambient light with light detection electronics located on the portable electronic device; and
adjusting the display on the portable electronic device based on the measured ambient light.

2. The method of claim 1 wherein measuring the ambient light with light detection electronics comprises:
detecting ambient light with a light sensor; and
defining the detected ambient light as the measured ambient light.

3. The method of claim 2 further comprising averaging the detected ambient light over a predefined time, wherein defining the detected ambient light as the measured ambient light comprises defining the average of the detected ambient light as the measured ambient light.

4. The method of claim 2 wherein the light sensor is part of a camera.

5. The method of claim 1 wherein adjusting the display on the portable electronic device comprises adjusting at least one of a size of displayed information, a backlight intensity of the display, and a display contrast based on the measured ambient light.

6. The method of claim 5 wherein adjusting the size of the displayed information based on the measured ambient light comprises increasing/decreasing the size of the displayed information as the measured ambient light increases/decreases.

7. The method of claim 5 wherein adjusting the backlight intensity of the display based on the measured ambient light comprises adjusting a pulse width modulation duty cycle of the display based on the measured ambient light.

8. The method of claim 5 wherein adjusting the backlight intensity of the display based on the measured ambient light comprises increasing/decreasing the backlight intensity as the measured ambient light decreases/increases.

9. The method of claim 5 wherein adjusting the display contrast based on the measured ambient light comprises adjusting at least one of a font type, font color, and a background color.

10. The method of claim 5 wherein adjusting the display contrast based on the measured ambient light comprises adjusting a bias voltage of the display based on the measured ambient light.

11. The method of claim 10 further comprising determining a display temperature and adjusting the bias voltage of the display on the portable electronic device based on the measured ambient light and the display temperature.

12. The method of claim 11 wherein determining the display temperature comprises measuring a temperature of the display.

13. The method of claim 11 wherein determining the display temperature comprises measuring an ambient temperature and determining the display temperature based on the measured ambient temperature.

14. The method of claim 1 wherein adjusting the display on the portable electronic device comprises adjusting at least two of a size of displayed information, a backlight intensity of the display, and a display contrast based on the measured ambient light.

15. The method of claim 1 further comprising generating a table of display adjustment values, wherein each display adjustment value corresponds to a different ambient light value.

16. The method of claim 15 wherein adjusting the display on the portable electronic device based on the measured ambient light comprises:
selecting the display adjustment value from the table of display adjustment values that corresponds to the measured ambient light; and
adjusting the display on the portable electronic device based on the selected display adjustment value.

17. The method of claim 15 wherein each display adjustment value corresponds to a size of displayed information, a display contrast, or a backlight intensity of the display on the portable electronic device to a different ambient light value.

18. The method of claim 17 wherein adjusting the display on the portable electronic device based on the measured ambient light comprises selecting a display adjustment value for at least one of the size of the displayed information, the display contrast, and the backlight intensity of the display from the table of display adjustment values based on the measured ambient light, and adjusting at least one of the size of the displayed information, the display contrast, and the backlight intensity based on the selected display adjustment value(s).

19. The method of claim 1 wherein adjusting the display on the portable electronic device based on the measured ambient light comprises automatically adjusting the display on the portable electronic device based on the measured ambient light.

20. The method of claim 1 wherein adjusting the display on the portable electronic device based on the measured ambient light comprises receiving a user input and adjusting the display on the portable electronic device based on the measured ambient light in response to the user input.

21. The method of claim 1 further comprising adjusting at least one of a gamma setting, a white point setting, and a black point setting of the display on the portable electronic device based on the measured ambient light.

22. The method of claim 1 further comprising adjusting a second display on the portable electronic device by using a conversion standard to convert display adjustment parameters generated based on the measured ambient light for a first display on the portable electronic device to display adjustment parameters for the second display on the portable electronic device.

23. The method of claim 1 wherein the display on the portable electronic device comprises one of a liquid crystal display, a thin film transistor display, a thin film diode display, an organic light emitting diode, and a super twisted nematic display.

24. A portable electronic device comprising:
light detection electronics located in the portable electronic device for determining a measured ambient light; and
a display controller for adjusting a display on the portable electronic device based on the measured ambient light.

25. The portable electronic device of claim 24 wherein the display controller comprises a size controller for adjusting a size of displayed information based on the measured ambient light.

26. The portable electronic device of claim 24 wherein the display controller comprises a backlight controller for adjusting a backlight intensity of the display based on the measured ambient light.

27. The portable electronic device of claim 26 wherein the backlight controller adjusts a pulse width modulation duty cycle of the display to control the backlight intensity of the display based on the measured ambient light.

28. The portable electronic device of claim 24 wherein the display controller comprises a contrast controller for adjusting a display contrast based on the measured ambient light.

29. The portable electronic device of claim 28 wherein the contrast controller adjusts at least one of a font type, a font color, and a background color based on th measured ambient light.

30. The portable electronic device of claim 28 wherein the contrast controller adjusts a bias voltage of the display to control the display contrast based on the measured ambient light.

31. The portable electronic device of claim 28 further comprising a temperature sensor for determining a display temperature.

32. The portable electronic device of claim 31 wherein the contrast controller adjusts the bias voltage of the display based on the measured ambient light and the display temperature.

33. The portable electronic device of claim 31 wherein the temperature sensor measures the display temperature.

34. The portable electronic device of claim 31 further comprising a temperature processor for determining the display temperature from an ambient temperature measured by the temperature sensor.

35. The portable electronic device of claim 24 further comprising a memory circuit for storing at least one table of display adjustment values, where each display adjustment value corresponds to a different ambient light value.

36. The portable electronic device of claim 35 wherein the display controller selects the display adjustment value corresponding to the measured ambient light from the table of display adjustment values and adjusts the display on the portable electronic device based on the selected display adjustment value.

37. The portable electronic device of claim 35 wherein the memory circuit stores a table of display adjustment values for each of at least one of a size of displayed information, a display contrast, and a backlight intensity of the display.

38. The portable electronic device of claim 24 further comprising a user input device for directing the display controller to adjust the display on the portable electronic device based on the measured ambient light.

39. The portable electronic device of claim 38 wherein the user input device comprises a control button disposed on a housing of the portable electronic device.

40. The portable electronic device of claim 38 wherein the user input device comprises a speaker for receiving an audible display command from the user.

41. The portable electronic device of claim 24 wherein the display controller automatically adjusts the display on the portable electronic device based on the measured ambient light.

42. The portable electronic device of claim 24 wherein the light detection electronics comprises a light sensor for detecting ambient light.

43. The portable electronic device of claim 42 wherein the light detection electronics further comprises a light processor for processing the detected ambient light and determining the measured ambient light from the processed ambient light.

44. The portable electronic device of claim 24 wherein the light detection electronics are part of a camera assembly.

45. The portable electronic device of claim 24 wherein the portable electronic device comprises one of a laptop computer, a calculator, a personal data assistant, a portable gaming system, and a portable music player.

46. The portable electronic device of claim 24 wherein the portable electronic device comprises a cellular telephone comprising a transceiver for transmitting and receiving wireless communication signals.

47. The portable electronic device of claim 46 wherein the light detection electronics are disposed in a camera assembly within the cellular telephone.

48. The portable electronic device of claim 24 wherein the display comprises one of a liquid crystal display, a thin film transistor display, a thin film diode display, an organic light emitting diode, and a super twisted nematic display.

49. The portable electronic device of claim 24 further comprising a second display on the portable electronic device, wherein the display controller adjusts the second display by using a conversion standard to convert display adjustment parameters generated based on measured ambient light for a first display on the portable electronic device to display adjustment parameters for the second display on the portable electronic device.
